(19) United States
(12) Patent Application Publication
(10) Pub. No.: US 2026/0050933 A1
(43) Pub. Date: Feb. 19, 2026

(54) SYSTEM AND METHOD FOR ENABLING ENTERPRISE DECARBONIZATION

(71) Applicant: Tellus Markets Corporation, Denver, CO (US)

(72) Inventor: Leonard W. Horton, III, Denver, CO (US)

(21) Appl. No.: 19/370,249

(22) Filed: Oct. 27, 2025

Related U.S. Application Data
(63) Continuation-in-part of application No. PCT/US2024/026670, filed on Apr. 26, 2024.
(60) Provisional application No. 63/462,369, filed on Apr. 27, 2023.

(51) Int. Cl. G06Q 30/018

(52) U.S. Cl. CPC G06Q 30/018

(57) ABSTRACT

A system for enabling enterprise decarbonization is disclosed. The system includes three platforms that can operate on a standalone basis, or in conjunction with the other platforms as Climate Suite. The three platforms include a Sustain platform configured to streamline emissions inventory, analytics and reporting and enable creation of emissions reductions that become deals in the PPA or Carbon marketplaces; a PPA platform configured to provide digital transaction services for clean power purchases and sales; and a Carbon platform configured to provide digital transaction services for purchases and sale of carbon credits and renewable energy certificates.

### CROSS-REFERENCE TO RELATED APPLICATION

This application is a bypass continuation-in-part of International Application No. PCT/US24/26670, which claims priority to U.S. Provisional Patent Application No. 63/462,369, filed on Apr. 27, 2023, the entire contents of which are incorporated herein by reference.

### FIELD

This relates generally to a system for enabling enterprise decarbonization within the field of sustainability.

### BACKGROUND

Organizations may set goals and targets to reduce the emissions from their operations. Existing solutions for enterprise decarbonization have numerous disadvantages. For example, current methods typically involve using multiple disconnected solutions, each covering a limited scope of functionality, that are offered by different vendors. Multiple disconnected solutions increase the time necessary for the user company to manage them, and may increase the cost for several reasons. Most importantly, these solutions do not include an integrated method to take concrete climate action but often rely on third party intermediaries with uncertain outcomes and high costs.

### SUMMARY

Achieving emissions reductions-referred to as enterprise decarbonization—requires the company to successfully manage numerous complex processes to achieve an actual physical outcome. Those processes include the following (and more). (1) Emissions inventory—Identifying all sources of emissions within the organization, collecting data about those emissions and assembling it into a unified view referred to as a Footprint; (2) Planning and analysis—Specifying alternative activities or methods to reduce emissions based on the organization's existing activities and emissions, preparing and analyzing scenarios of various potential activities, then selecting one or more activities or methods for implementation; (3) Action—To actually achieve emissions reductions, there are two basic methods: operational changes (e.g. modifying the way the organization operates to reduce emissions, such as upgrading to a more efficient HVAC system) or market based reductions (e.g. purchasing clean power, renewable energy certificates (“RECs”) or carbon credits to reduce or offset their emissions); and (4) Reporting—Preparation of reports about these activities for stakeholders, and to meet regulatory requirements in the jurisdictions where they operate.

This disclosure relates to systems and methods that enable users to actually achieve enterprise decarbonization, including without limitation understanding their emission footprint, analyzing potential reduction pathways (including both operational and market based reductions) and executing market based reductions to reduce or offset their emissions.

Various embodiments of the disclosure deliver all of the functionality and processes necessary to achieve enterprise decarbonization with an intuitive interface designed to simplify the complexity, combined with marketplaces that provide a streamlined digital pathway to emission reductions, enabling decarbonization with real world effect. In one embodiment, the disclosed system (also referred to herein as “Climate Suite”) includes three main platforms (i.e., the Sustain platform, the Carbon platform, and the PPA platform) is disclosed. Each of these platforms can operate on a standalone basis, or in conjunction with the other platforms as Climate Suite.

From a summary perspective, the advantage of the proposed embodiments is that it provides efficient digital enterprise decarbonization, by combining emissions inventory, analytics and planning, plus reporting, with digital marketplaces. This comprehensive solution enables the real world outcome of enterprise decarbonization initiated from a fully digital environment.

A major advantage of the embodiments of the disclosed system is its two digital marketplaces, which are (1) unique—no competitive solution includes two marketplaces enabling users to purchase clean power, carbon credits and RECs; (2) integrated—marketplace software and operations are an integral part of the solution workflows, not an afterthought, (3) digital—these are true digital marketplaces not partner referral networks like some competitors; (4) efficient—marketplaces enable users to transact far more efficiently than brokers or other alternatives; and (5) lower cost—buyers pay no fees to access the marketplaces plus all transaction fees are paid by sellers.

Another crucial advantage of this embodiment of the disclosed system is process efficiency. In particular, this embodiment provides (1) simplicity—highly intuitive interface with comprehensive workflows makes managing activities and achieving results easier; (2) regulatory compliance—functionality enables creation of reports to ensure regulatory compliance at the touch of a button, (3) connectivity—direct digital connection between products eliminates need for intermediate steps, such as manual entry or creating spreadsheets to transfer data between applications; (4) automatic updating—when transactions are completed in marketplaces, details are automatically sent to the emissions inventory module, updating the user's emissions footprint; and (5) eliminates data transfer errors—all data transfer is electronic and seamless, eliminating the need for spreadsheets, emails or other manual methods.

Another important advantage of the embodiments of the disclosed system is cost savings. In particular, cost savings can be achieved in (1) operations—the comprehensive application with streamlined workflows simplifies sustainability department operations, allowing smaller teams to do more without increasing headcount and personnel expense; (2) software license-only need to purchase one software license not many, reducing costs; (3) no other software fees-no charge for onboarding, setup or implementation, unlike competitors who charge multiple fees in addition to basic software license fee; and (4) lower cost for marketplace purchases and market based reductions, due to marketplaces with no onboarding fees and transaction fees paid by sellers.

Further, the embodiments of the disclosed system can provide time savings. In particular, time savings can be achieved (1) through the process efficiency described herein, (2) in procurement—research, negotiate and close one solution instead of three, resulting in material savings of personnel time; (3) in onboarding—efficient online onboarding process covers all three products, and saves significant time as compared to onboarding to three separate applications; and (4) in operations—unified workflow is much easier to use than three separate applications, saving user time.

### BRIEF DESCRIPTION OF THE DRAWINGS

FIG. 1 is an exemplary system diagram of a system for enabling enterprise climate action, according to an embodiment of the disclosure.

FIG. 2 illustrates the exemplary workflow of the various platforms within the system FIG. 1, according to an embodiment of the disclosure.

FIG. 3 illustrates the exemplary modules of the sustain platform of the disclosed system of FIG. 1, according to an embodiment of the disclosure.

FIGS. 4A-4V illustrates various exemplary user interfaces (UIs) of the system of FIG. 1, according to embodiments of the disclosure.

FIG. 5 is a block diagram illustrating the exemplary hardware components of the platforms of the system of FIG. 1, according to an embodiment of the disclosure.

### DETAILED DESCRIPTION OF THE PREFERRED EMBODIMENTS

In the following description of preferred embodiments, reference is made to the accompanying drawings which form a part hereof, and in which it is shown by way of illustration specific embodiments, which can be practiced. It is to be understood that other embodiments can be used, and structural changes can be made without departing from the scope of the embodiments of this disclosure.

This disclosure relates to systems and methods that enable users to achieve enterprise decarbonization. In one embodiment, the disclosed system-called Climate Suite-includes three main platforms (i.e., the Sustain platform, the Carbon platform, and the PPA platform) is disclosed. Each of these platforms can operate on a standalone basis, or in conjunction with the other platforms as Climate Suite.

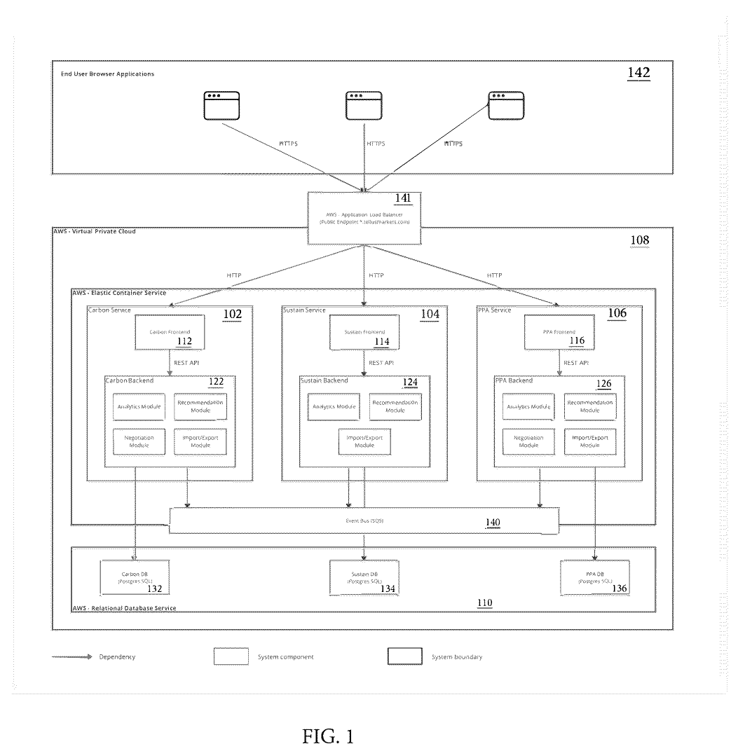

FIG. 1 is an exemplary system diagram of a system for enabling enterprise decarbonization, according to an embodiment of the disclosure. In this embodiment, Climate Suite is comprised of the Carbon Platform (i.e., Carbon Service) 102, Sustain Platform (i.e., Sustain Service) 104, and PPA Platform (i.e., PPA Service) 106 which can be hosted by an elastic container service 107 on a virtual private cloud 108 (or any other type of cloud services or networks). Each of these platforms can have the features and functions detailed below. The Carbon Platform 102 can include a front end 112 and back end 122. The Sustain Platform 104 can include a front end 114, and back end 124. The PPA Platform 106 can also include a front end 116 and back end 126. The front end and the back end of the same platform can be in communication with each other. The 3 platforms 102, 104, 106 can be interconnected via their back ends 122, 124, 126 by, for example, an event bus (SQS) 140. The event bus enables an efficient way for the carbon and PPA requirements creation, and faster notifications and updates for pending and achieved reduction tracking, which will be discussed in detail below.

The virtual private cloud can also host a relational database service (or any other suitable types of database service) 110 that includes a Carbon database 132 connected to the Carbon backend 122, a Sustain database 134 connected to the Sustain backend 124, and a PPA database 136 connected to the PPA backend 126.

Climate Suite, comprised of the Carbon Platform 102, Sustain Platform 104, and PPA Platform 106 can be connected to an Application Load Balancer 141, which can, in turn, communicate with one or more end user browser applications 142. The one or more end user browser applications 142 can be web-based, app-based, etc. and can run on any type of devices.

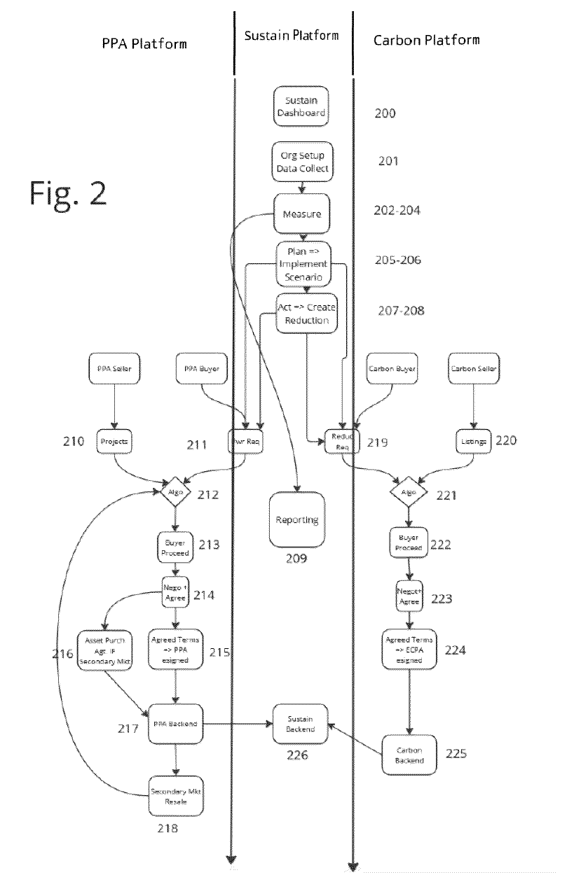

FIG. 2 illustrates the exemplary workflow of Climate Suite comprised of the Sustain Platform 104, the PPA Platform 106, and the Carbon Platform 102 of the system illustrated in FIG. 1.

The Sustain platform can be connected to, and its workflows are integrated with, the PPA platform and the Carbon platform. The PPA platform and the Carbon platform may not be connected with each other.

### The Sustain Platform

The Sustain platform is configured to streamline emissions inventory, analytics and planning, and reporting. The Sustain platform also enables the direct creation of potential future emissions reductions that become drafts deals in the PPA or Carbon marketplaces. After deals are activated and completed in each marketplace, deal data is automatically sent back to the Sustain platform and updates app data for analysis, planning and reporting.

Data exchange between products can be via an API, all within one virtual private cloud or equivalent segregated environment. All apps can share a single sign on and a single fully online onboarding process.

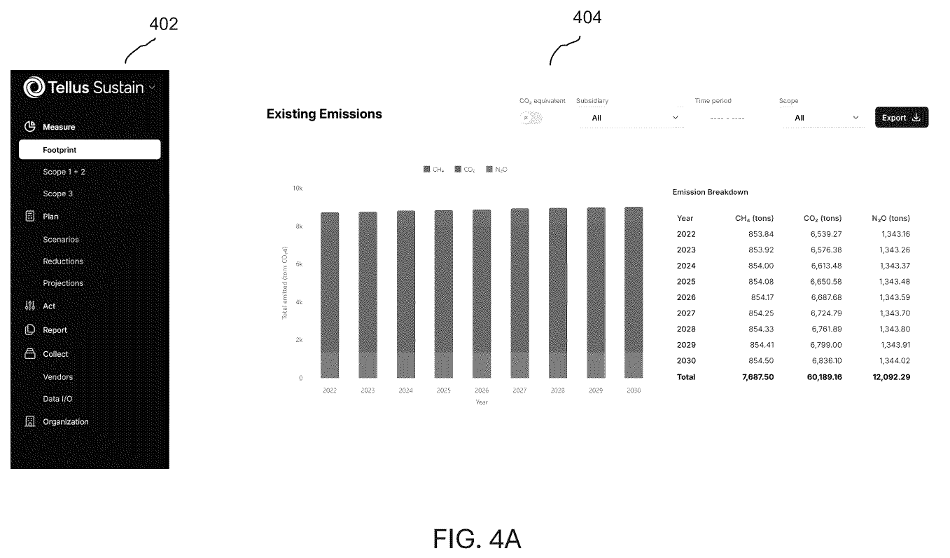

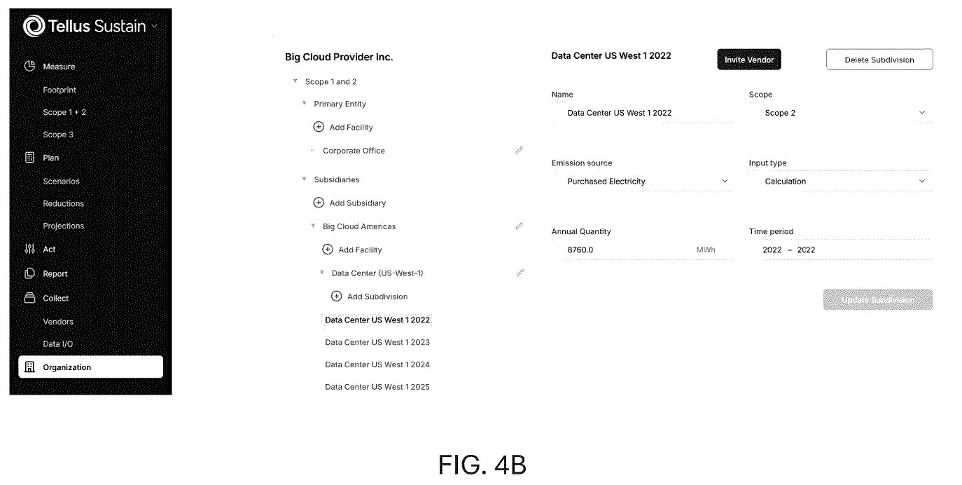

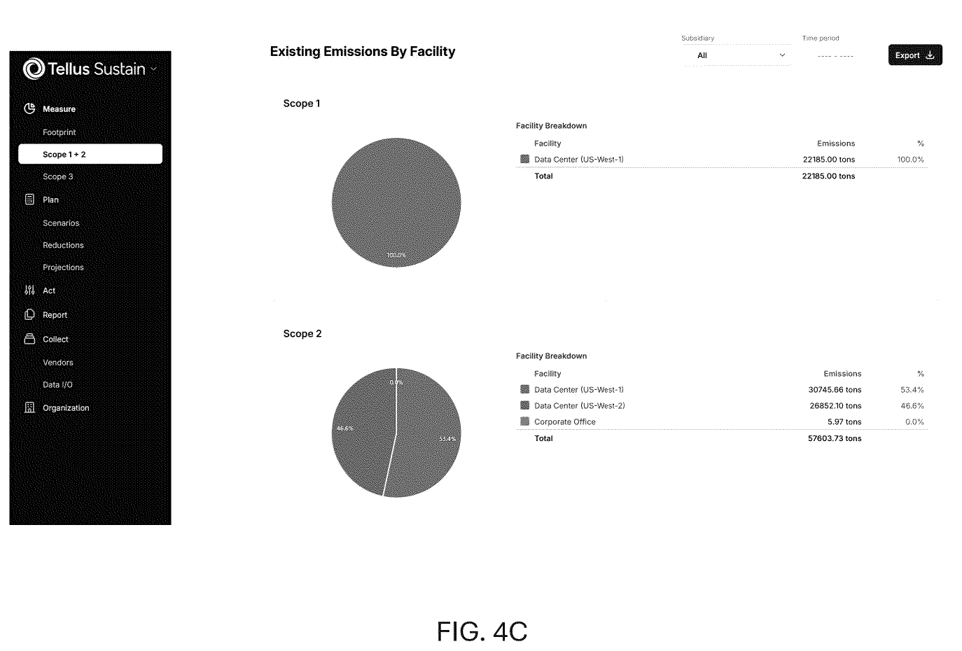

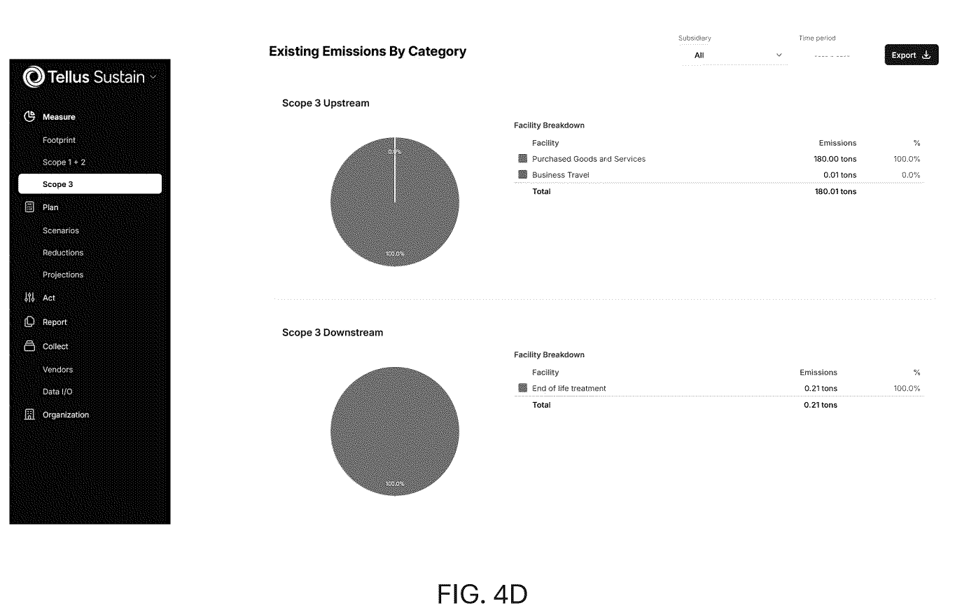

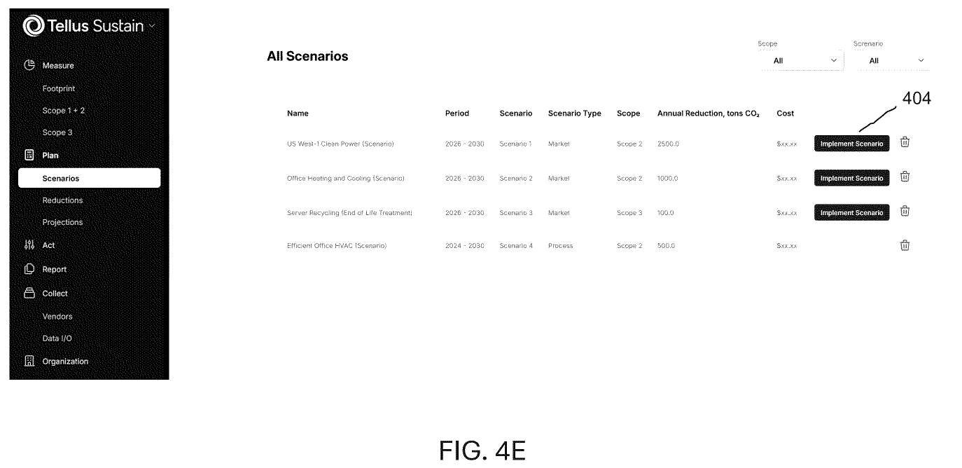

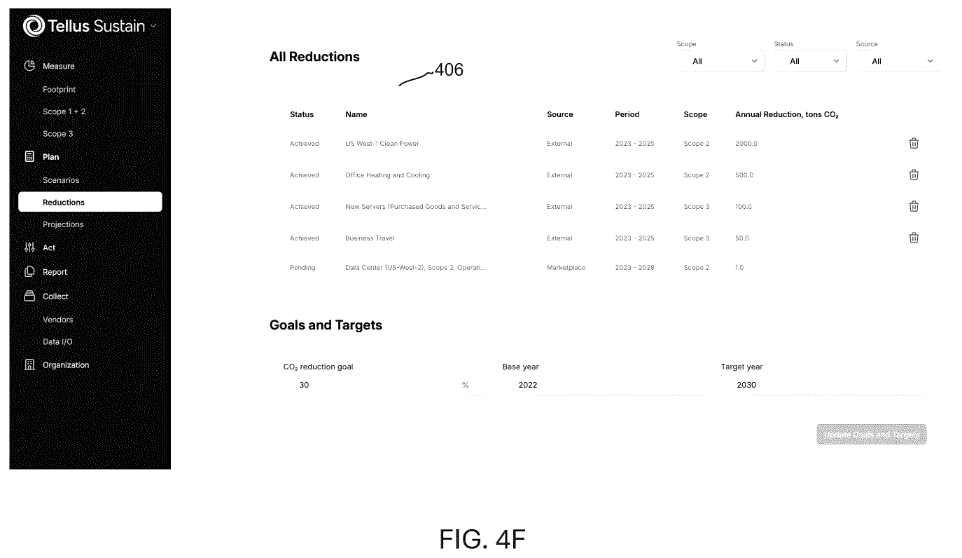

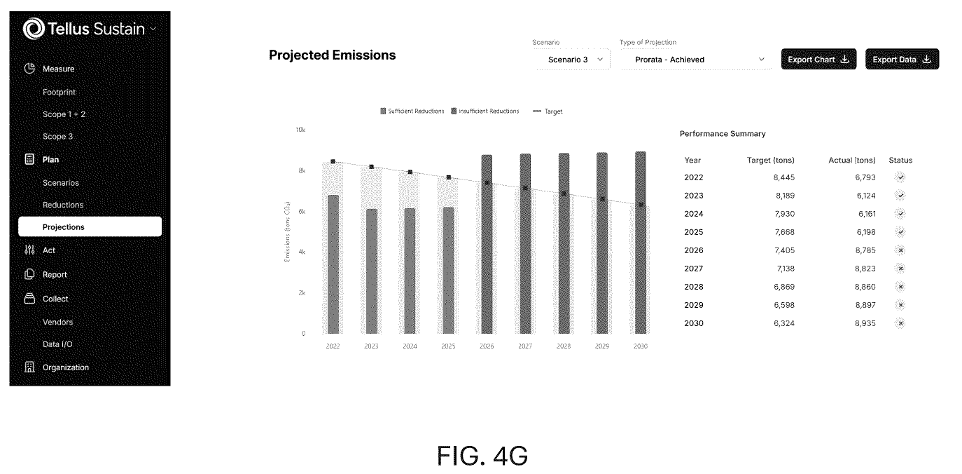

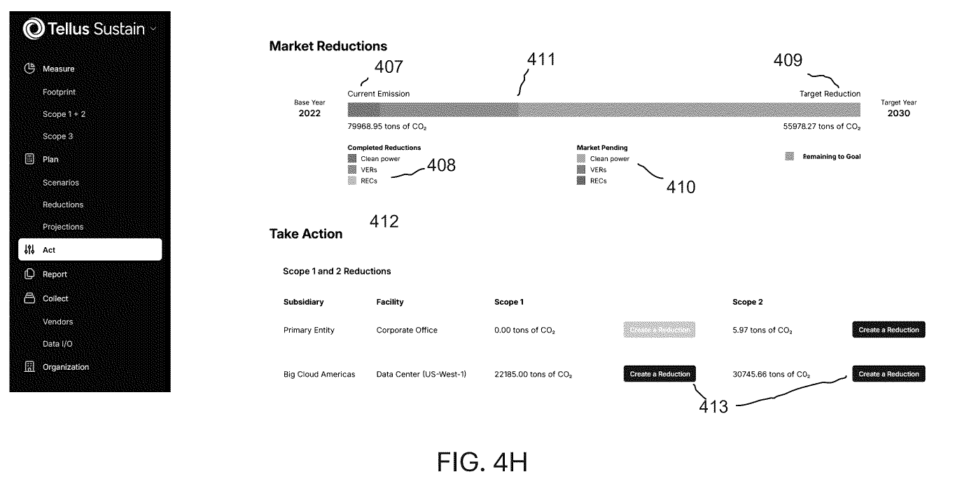

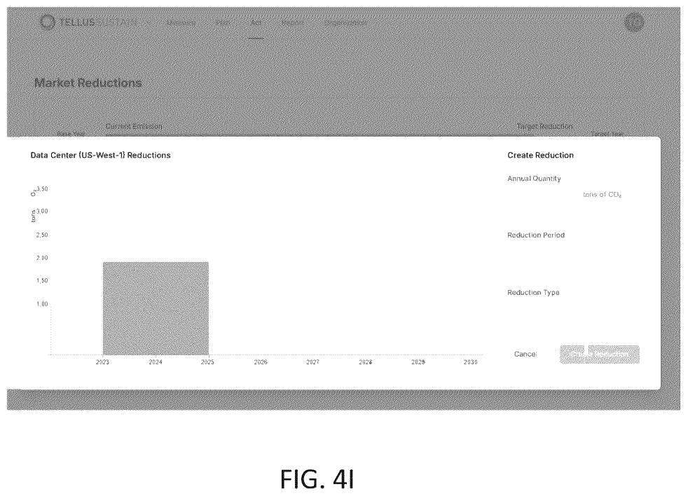

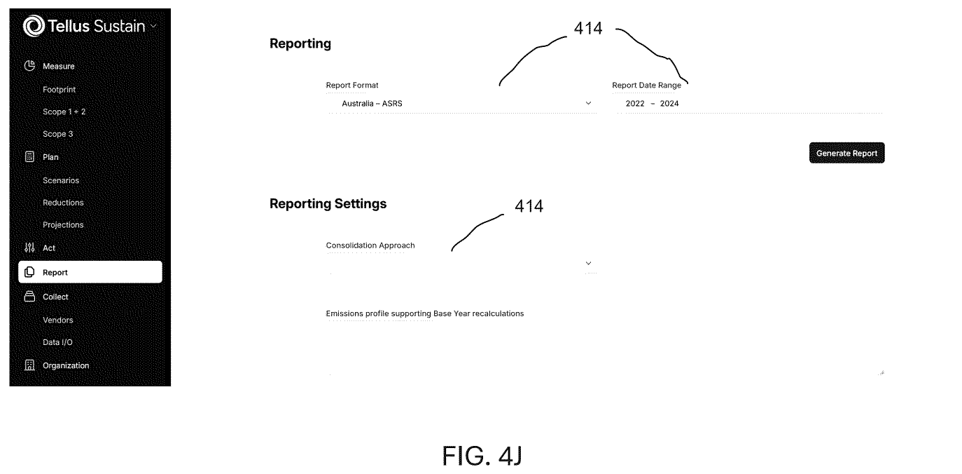

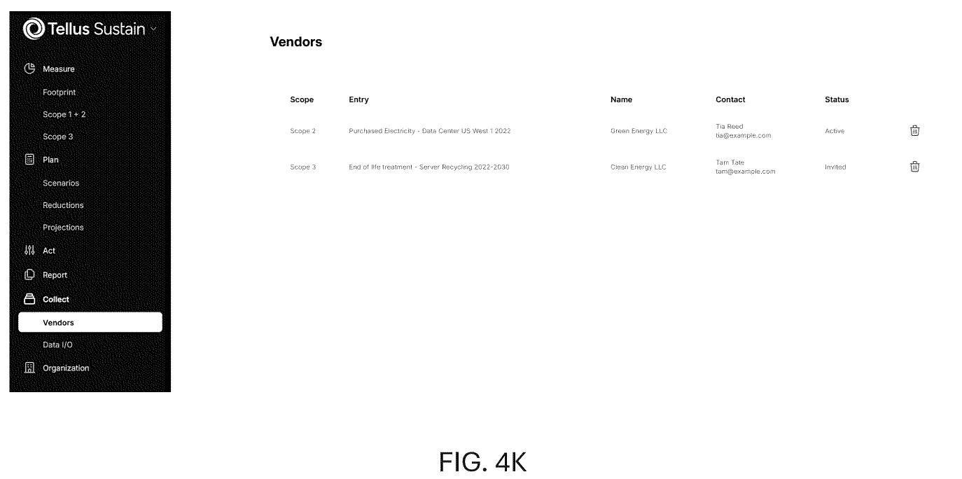

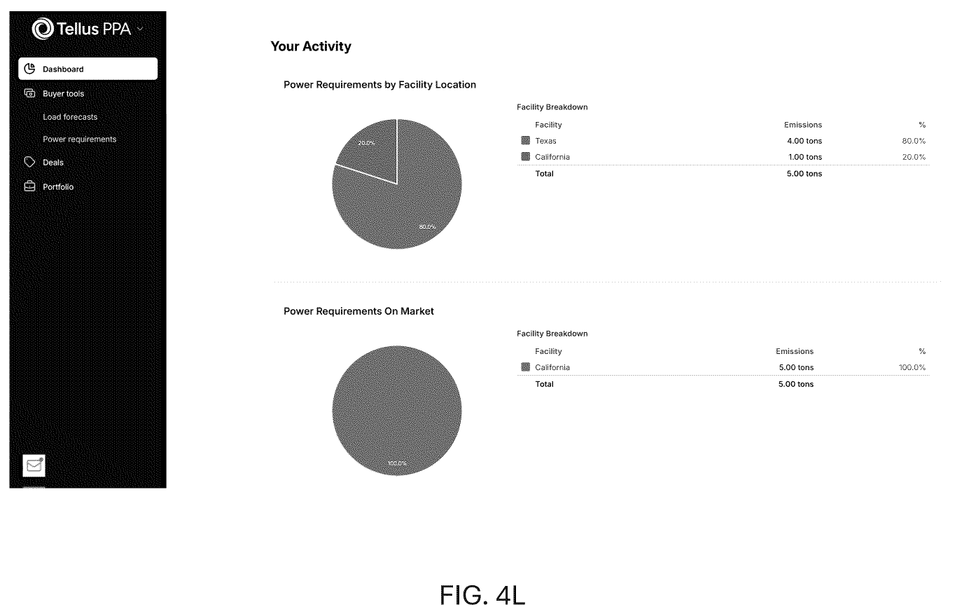

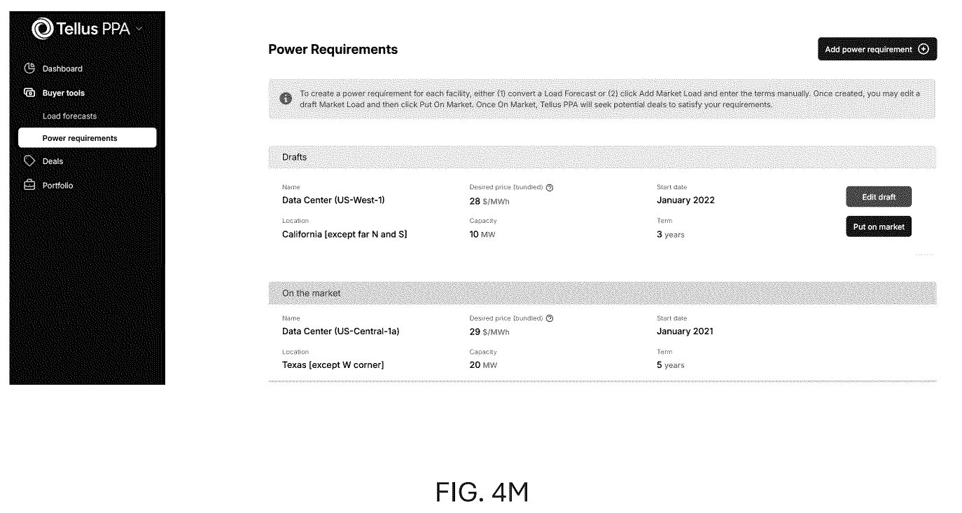

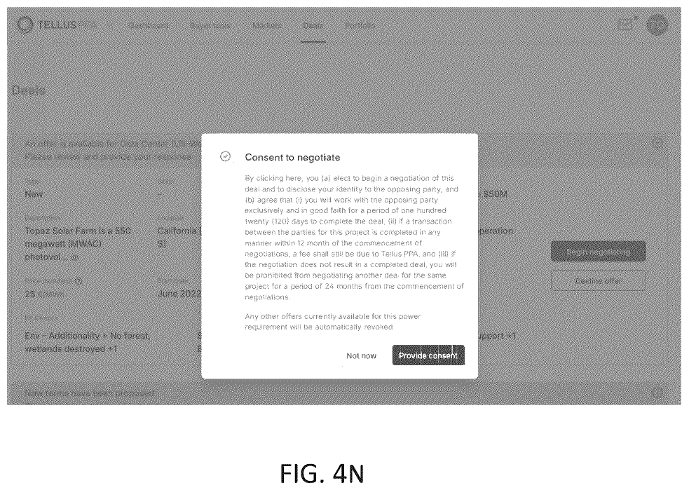

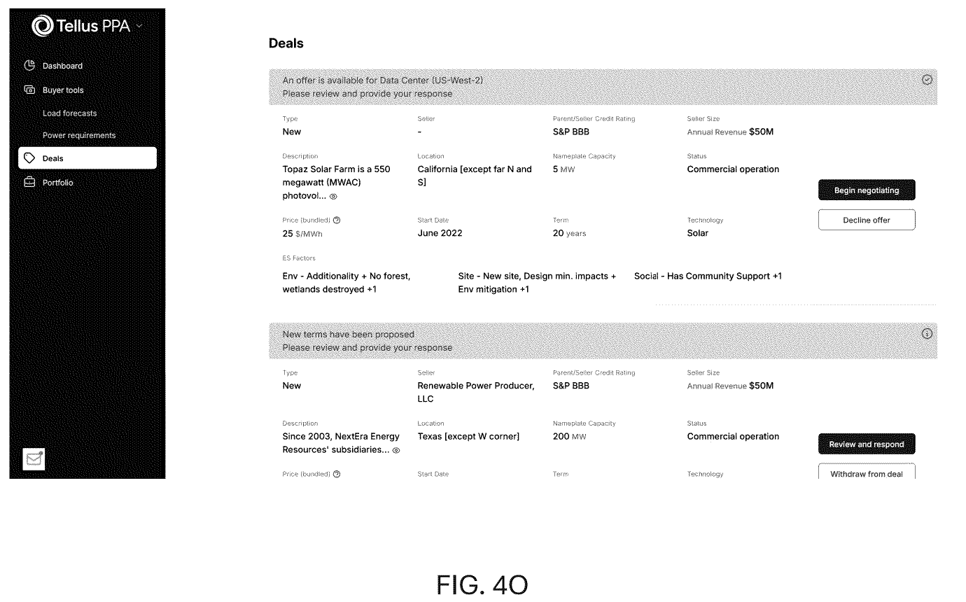

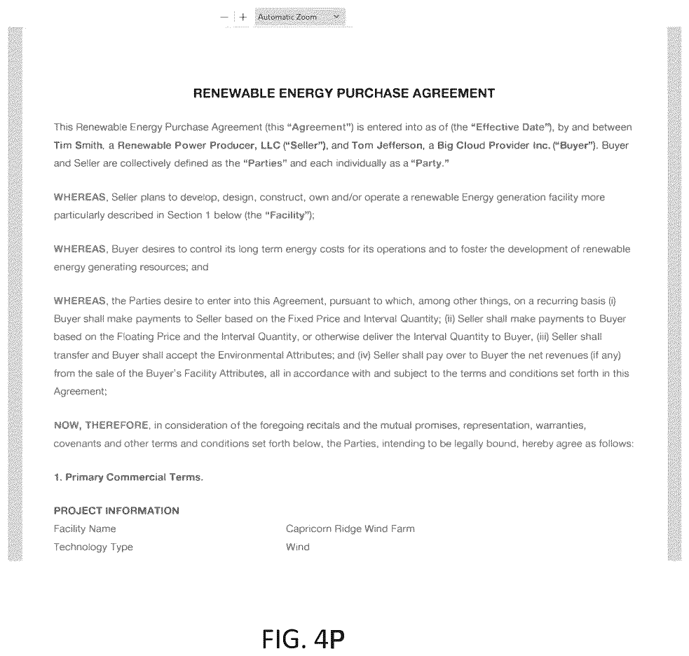

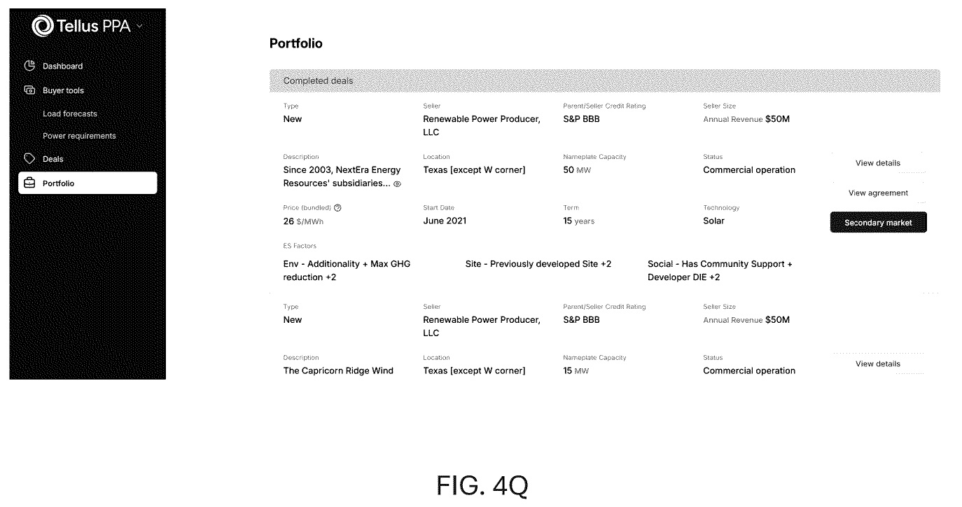

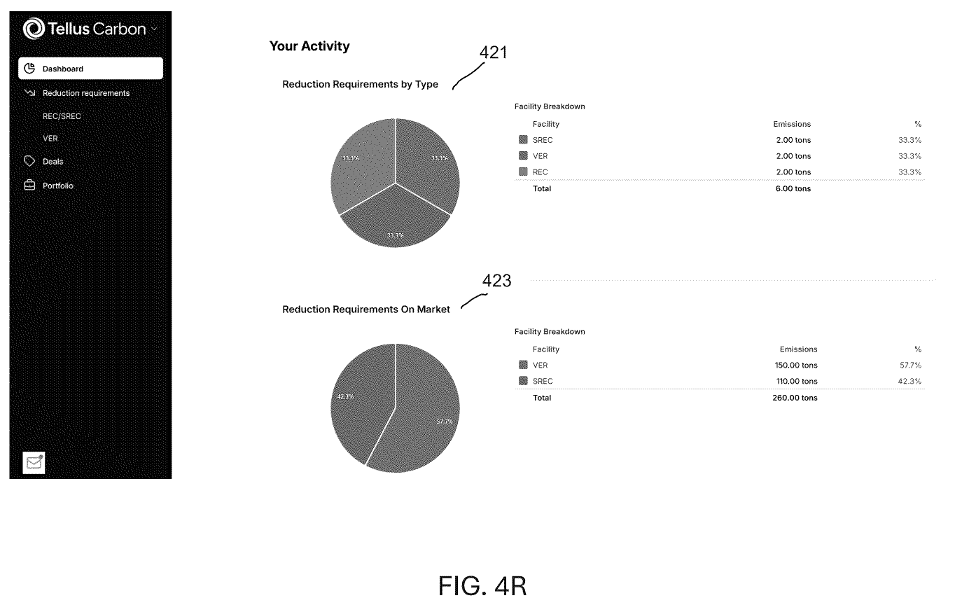

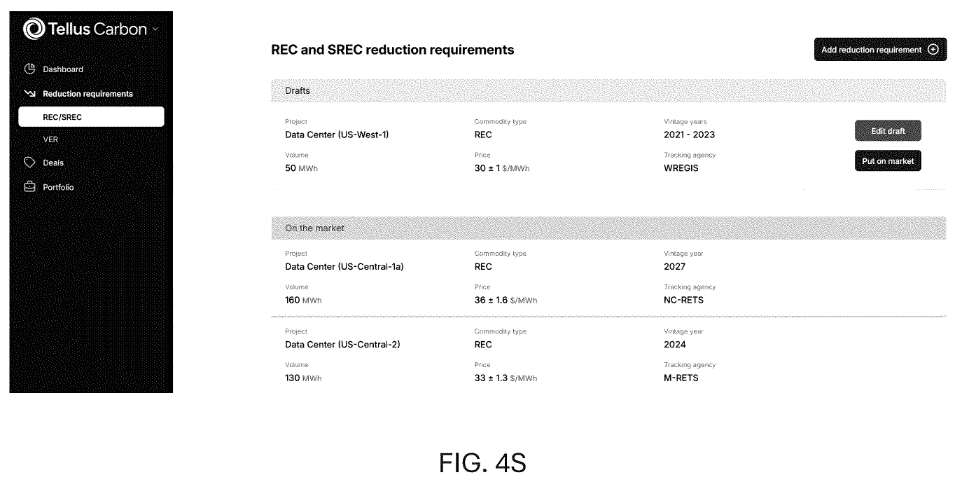

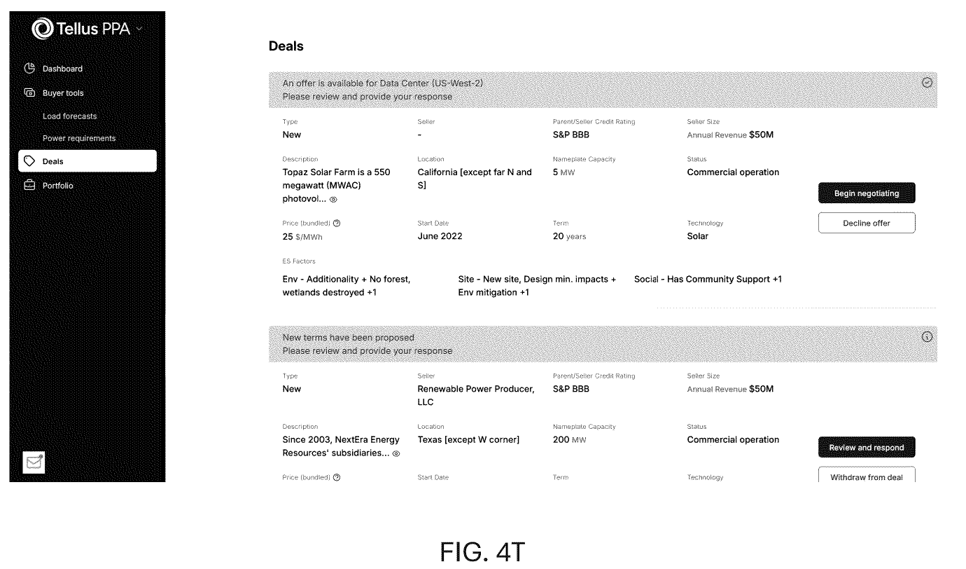

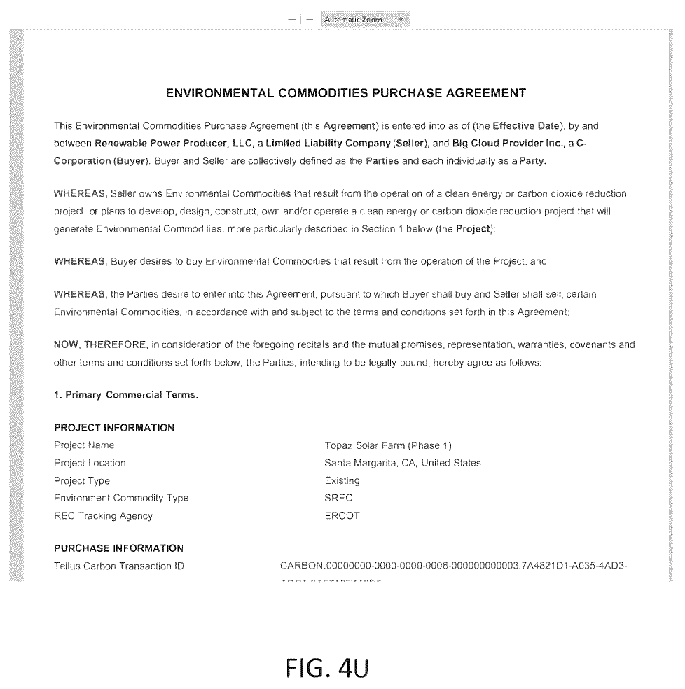

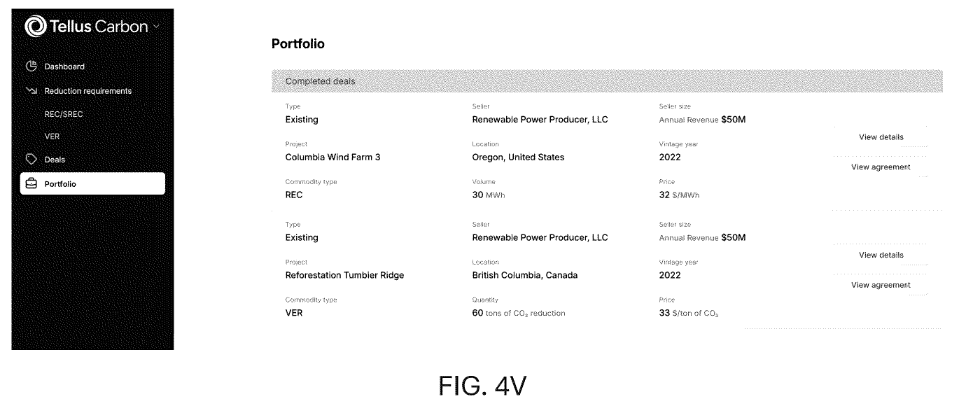

Referring to FIG. 2, first, sustain dashboard can be provided to the user. (Step 200) FIG. 4A illustrates an exemplary sustain dashboard 400. The dashboard includes navigation 402 corresponding to the different modules (discussed below) of the sustain module.

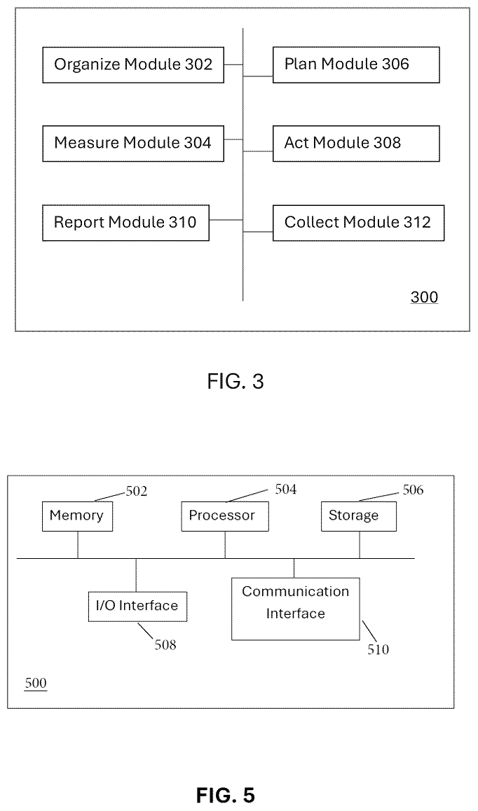

In one embodiment, as shown in FIG. 3, the sustain platform 300 can include 5 major modules: Organization module 302, Measure module 304, Plan module 306, Act module 308, Report module 310, and Collect module 312. The functions of each of these modules are discussed in detail below with reference to the flow chart of FIG. 2.

The Organization module 302 enables the user to create a customized data warehouse structure that reflects the structure of the user's organization. Data warehouse can organize data inputs pursuant to the structure created and enable input of emissions data from direct measurement (e.g., manual entry or API) or estimation formulas. (Step 201) An example of a user interface (UI) of the Organization module 302 is shown in FIG. 4B.

The Data Input/Output section of the Collect module 312 can enable the import of emissions data from other sources, the import of data regarding purchases of clean power, RECs or carbon offsets done outside Climate Suite, the import of scenarios, and the export of emissions data.

The Measure module 304 enables the user to create different views of its emissions footprint, organized by subsidiaries, facilities and other subdivisions, Scope 1+2 or Scope 3 emissions, and time periods. (Steps 202-204) FIGS. 4C and 4D provide exemplary user interfaces (UIs) of the Measure module 304 showing the existing emissions organized by one or more of subsidiary, facility, category, time period, and scope.

The Plan module 306 enables the user to (1) view the details of all scenarios they have created in FIG. 4E, (2) view their achieved and potential emissions reductions in tabular format (“All Reductions”), and specify its climate goals by setting Base Year, Target Year and the percentage reduction desired all as shown in the exemplary UI in FIG. 4F, and (3) view in customizable graphic format the pro rata reductions required each year to achieve goals, including the effect of previously achieved reductions and potential scenarios, as shown in the exemplary UI in FIG. 4G.

### (Steps 205-206)

The Plan module 306 also enables users to create reductions specified in a scenario using the “Implement Scenario” selector 404 (FIG. 4E), which enables a user to create a potential market based emissions reduction by purchasing clean power, RECS or carbon credits. Details of the potential reduction created are automatically sent to the relevant marketplace as a draft deal and (1) adds the reduction in “Pending” status to the All Reductions table 406 (FIG. 4F) and (2) add it to the Market Reductions graph on the Act tab (FIG. 4H). After draft deals are edited, activated and completed, deal data is automatically sent back to the Sustain platform from the PPA platform or the Carbon platform (as the case may be) and updates “Completed Reductions” on the All Reductions table 406 in the Plan module 306 and on the Market Reductions portion of the Act module 408.

The Act module 308 can generate planning graphs (example shown in FIG. 4H) that show, for example: (a) Base Year emissions 407, Target Year emissions 409 and CO2 reductions necessary to meet specified reduction goal between Base Year and Target Year 411; (b) progress toward meeting specified goal updated in real time based on actions and activity; (c) effect of existing purchases of clean power, RECs and carbon offsets on emissions as “Completed Reductions;” 408 and (d) potential effect or new pending transactions as “Market Pending” 410.

The Act module 308 can also facilitate a “Take Action” section 412, which shows various major subdivisions created in data warehouse, and the emissions generated by each within specified Base Year to Target Year time period. The “Take Action” section 412 can also include a “Create a Reduction” selector 413 that enables a user to select a portion of emissions from each subdivision and create a potential emissions reduction by purchasing clean power, RECS or carbon offsets. FIG. 4I provides an exemplary UI for the “Create a Reduction” operation. Potential reduction created is automatically sent to relevant marketplace as draft deal and updates “Market Pending” part of graph. After draft deals are edited, activated and completed, deal data is automatically sent back to the Sustain platform from the PPA platform or the Carbon platform (as the case may be) and updates “Completed Reductions” portion of planning graph. (Step 226)

The Report module 310 can also generate reports in specified formats such as Greenhouse Gas Protocol, IFRS/ISSB and others. (Step 209) FIG. 4J provides an exemplary UI of the Report module 310 showing various selectable settings 414.

The Collect module 312 is configured to (1) manage vendors enrolled in the automated data collection process; and (2) enable data input and output via uploads and downloads. FIG. 4K provides an exemplary UI for showing vendor information.

The Sustain platform, whether stand alone or in combination with the other platforms, can provide a number of advantages over existing solutions. For example, existing solutions either offer no reporting, or require the purchase of additional add-on software to get reporting. Existing solutions have limited or no connection to marketplaces. The Climate Suite of the disclosed embodiments simplifies climate action—providing a streamlined, intuitive and fully digital method for enterprise emissions reductions.

### PPA Platform

Referring again to FIG. 1, the PPA platform 106 is configured to provide digital transaction services for clean power purchases and sales. The PPA platform 106 enables an end to end fully digital process and the operation of its workflows creates a marketplace.

Referring to FIG. 2, specifically, the PPA platform can allow a seller to create a project description to list power for sale and provide tools for a seller to manage project credit rating during sales process. (Step 210) An exemplary UI (e.g., Dashboard) for presenting adding, editing, and placing projects on the market is provided in FIG. 4L. Additionally, the PPA platform can allow a buyer to create a Power Requirement to seek power for sale and provide tools for a buyer to forecast power load and convert to a Power Requirement. (Step 211) An exemplary UI for presenting adding, editing, and putting Power Requirements on the market is provided in FIG. 4M.

The PPA platform can use an algorithm to identify congruence between Projects and Power Requirements to provide “Recommended deals” to buyers, without disclosing seller name. (Step 212) Only when a buyer consents to negotiate is the buyer's name divulged and negotiation proceeds. (Step 213) FIG. 4N provides an exemplary “Consent to Negotiate” UI for a buyer to provide consent. The PPA platform also enables a buyer and a seller to negotiate all key terms online. (Step 214) FIG. 4O provides an exemplary UI for the parties to negotiate terms of a deal. When negotiation is successful and completed, terms automatically populate a document template provided by the PPA platform to create a Power Purchase Agreement. (Step 215 FIG. 4P) provides an exemplary purchase agreement 416 generated by the PPA platform. After execution, signed Power Purchase Agreements are collected in the user's Portfolio shown in FIG. 4Q. The Power Purchase Agreement 416 can be a proprietary form that can be electronically signed between parties within the platform.

Additionally, the PPA platform provides a secondary market that enables the resale of portions of PPAs purchased on platform. (Step 216) The PPA platform only allows a separate workflow to be reached if the PPA is purchased on the PPA platform and enables specification of volume and term desired to be sold. Once specified, the volume and term offered goes into the pool for potential algorithmic sort just like new deals. The PPA platform allows a buyer and a seller to negotiate purchase price and premium terms online. When negotiation is successful and completed, the PPA platform automatically populates a document template with the finalized terms to create an Asset Purchase Agreement. The Asset Purchase Agreement can be a proprietary form that is electronically signed between parties within the platform.

The signed Power Purchase Agreement or Asset Purchase Agreement (for resale on secondary market) can be stored and processed by the PPA backend. (Step 217) The Asset Purchase Agreement can facilitate resale on the secondary market. (Step 218)

There are a number of advantages that the PPA platform discussed above offers over existing solutions. For example, the PPA platform provides an efficient transaction process that can be completed in days or weeks, not months as required by existing solutions. The PPA platform also incurs lower transaction costs than existing solutions. There are no upfront costs, and transaction-based fees on deal completion are far lower than those of existing platforms. There are low or no legal costs associated with the PPA platform. Integrated PPA negotiations and documentation limits or eliminates need for lawyers and legal fees.

Furthermore, PPA platform reduces risk for the buyers. This is achieved by allowing the buyer to resell portion of power purchased in secondary market. The PPA platform also simplifies managing project credit rating by providing unique software tools that enable sellers to digitally manage project credit rating during sales process. The PPA platform attracts a wide pool of buyers when it is connected to the Sustain platform, which provides a wide and expanding pool of buyers for clean power. PPA platform also provides open opportunities for buyers. There are no marketplace barriers to entry provides broadest opportunity set for the buyers.

### Carbon Platform

Referring again to FIG. 1, the Carbon platform 102 is designed to provide digital transaction services for purchases and sale of carbon offsets and renewable energy credits. It provides an end to end fully digital process and the operation of its workflows creates a marketplace. An exemplary dashboard UI of the Carbon platform is provided in FIG. 4R. The dashboard shows the user's activities including, for example, a breakdown of reduction requirements by type 421 and a breakdown of reduction requirements on the market 423.

In one embodiment, the Carbon platform 102 provides a number of functions. Referring to FIG. 2, for example, it allows a seller to create a listing description to list either RECs/SRECs or carbon offsets for sale. (Step 220) An exemplary UI for presenting adding, editing, and putting listings on the market is provided in FIG. 4S. The Carbon platform 102 also allows a buyer to create a Reduction Requirement to seek environmental commodities to be purchased. (Step 219) The Carbon platform uses an algorithm to identify congruence between Listings and Reduction Requirements to provide “Offers” to buyers. (Step 221)

In one embodiment, the Carbon platform requires the buyer to act to commence negotiations. (Step 222) FIG. 4T provides an exemplary UI for the buyer to review and respond to a seller's listing. It allows the buyer and the seller to negotiate all key terms online. (Step 223) When negotiation is successful and completed, the Carbon platform automatically populates a document template with the finalized terms to create an Environmental Commodities Purchase Agreement (ECPA). (Step 224) FIG. 4U provides an exemplary ECPA 418 generated by the PPA platform. The Environmental Commodities Purchase Agreement can be a proprietary form that is electronically signed between parties within the platform. After execution, signed Environmental Commodities Agreements are collected in the user's Portfolio shown in FIG. 4V. Additionally, the Carbon platform can include a riskless digital settlement process than will make use of a third-party service provider.

The completed ECPA can be stored and processed by the Carbon backend. (Step 225) Both the PPA backend and the Carbon backend can be connected to the Sustain backend and share agreements and other data with the Sustain backend. (Step 226)

The Carbon platform provides a number of advantages over comparable existing solutions. For example, Carbon platform enables granular matching. Highly granular search enables matching based on user specific criteria. Carbon platform also offers riskless fully digital settlement through, e.g., a fully digital process using third party settlement provider. In addition, Carbon platform has the flexibility to support future projects and project financing and enables project financing. By connecting with Sustain platform, Carbon platform can have access to a wide and expanding pool of buyers for carbon offsets and RECs.

When operated in combination in one system as Climate Suite, the Sustain platform, PPA platform, and Carbon platform can provide additional advantages over existing solutions. Specifically, the Climate Suite provides connected and unified workflows that are much more efficient than disconnected solutions, greatly reducing personnel time. The overall cost is lowered by offering a single software license instead of multiple licenses. In some embodiments, buyer transactions in marketplaces offered by the system have no onboarding or implementation fees and transaction fees paid by sellers. The system with combined platforms can offer automated data exchange, thereby simplifying operation and eliminating errors. The system offers the only available solution with direct connection to two marketplaces, for clean power and carbon reductions. In general, the system can help simplify climate action by providing a simple and fully digital method for enterprise emissions reductions.

It should be understood that at least some of the steps in FIG. 2 can be performed in a different order than the one shown in the figure and at least some of the steps can be performed concurrently.

FIG. 5 illustrates the exemplary hardware components of the platforms of the system of FIG. 1 such as Carbon Platform (i.e., Carbon Service) 102, Sustain Platform (i.e., Sustain Service) 104, and PPA Platform (i.e., PPA Service) 106 of FIG. 1. The hardware components of FIG. 5 can be shared by multiple platforms. Alternatively, each platform 102, 104, 106 can have separate hardware components and the platforms can be in communication via a network.

As illustrated in FIG. 5, the hardware components of a platform (or shared by multiple platforms) include a memory 502, a processor 504, a storage 506, an input/output (I/O) interface 508, and a communication interface 510.

Processor 504 may include any appropriate type of general-purpose or special-purpose microprocessor, digital signal processor, or microcontroller. Processor 504 may be configured to receive data and/or signals from user interface such as a keypad or a touch screen, and/or other devices on the network and process the user input and received data and/or signals to perform the steps of FIG. 2.

Processor 504 may execute computer instructions (program codes) stored in memory 502 and/or storage 506, and may perform functions in accordance with exemplary techniques described in this disclosure. Memory 502 and storage 506 may include any appropriate type of mass storage provided to store any type of information that processor 504 may need to operate. Memory 502 and storage 506 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 502 and/or storage 506 may be configured to store one or more computer programs that may be executed by processor 504 to perform exemplary functions of one or more of the platforms described above. The program(s) may also be executed by processor 504 to provide an interface for interacting with a user.

Memory 502 and/or storage 506 may be further configured to store information and data used by processor 504. Memory 502 and/or storage 506 may be configured to store real-time streaming or pre-downloaded video content and/or software updates to the exercise machine.

The various modules of FIG. 1 can be implemented in hardware, software, firmware, or a combination of any of the above. If implemented in software, the modules can be stored in Memory 502 and storage 506 of one or more systems 500.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. An enterprise decarbonization system comprising:
a sustain platform comprising:
an organization module configured to:
enable a user to create a customized data warehouse structure;
organize data inputs pursuant to the data warehouse structure;
enable input of emissions data;
identify one or more vendors that can provide each piece of Scope 2 and 3 data; and
initiate automated data collection process with each of the one or more identified vendors;
a collect module configured to:
manage vendors enrolled in an automated data collection process; and
enable data input and output via uploads and downloads;
a measure module configured to:
visualize user's emissions footprint, including one or more filters to create customized views and identify specific data within the emissions footprint;
visualize user's Scope 1 and Scope 2 emissions, including numerous filters to create customized views; and
visualize user's Scope 3 emissions, including one or more filters to create customized views;
a plan module configured to:
track status of all reductions undertaken by the user, and enable input of emissions reductions goal from a base year to a target year that will drive operation of the enterprise decarbonization system;
track and display details of all scenarios that have been constructed by the user, with each scenario including an implement scenario button which causes the details of the scenario to create draft transactions in the relevant marketplace within the enterprise decarbonization system; and
provide data visualization that enables the user to build a chart, by including reductions achieved or pending and scenarios, showing the user's progress toward meeting decarbonization goals on an annual basis;
an act module configured to:
generate a unified planning graph that shows base year emissions, target year emissions, and CO2 reductions necessary to meet specified reduction goal between the base year and the target year, the effect of existing purchases of clean power, RECs and carbon offsets on emissions, or potential effect or new pending transactions; and progress toward meeting specified goal updated in real time; and
list Scope 1, 2 and 3 emissions coming from various activities and facilities within the user's organization; and enable users to manually specify the portion of the emissions coming from each facility to be reduced using a specified marketplace purchase.
a report module configured to:
enable input of various reporting settings and approaches, and generate reports in various formats necessary to ensure regulatory compliance in applicable jurisdictions.

2. The enterprise decarbonization system of claim 1, wherein the emissions data is obtained from direct measurement or calculations made using user data plus estimation formulas.

3. The enterprise decarbonization system of claim 1, wherein the collect module comprises a data input/output section configured to enable import of emissions data, import of data regarding purchases of clean power, RECs or carbon offsets, import of scenarios, and export of emissions data.

4. The enterprise decarbonization system of claim 1, wherein the measure module is further configured to organize the plurality of views of emissions footprint by one or more of subsidiaries, facilities, scopes, and time periods.

5. The enterprise decarbonization system of claim 1, wherein the plan module is further configured to enable specifying climate goals by setting a base year, target year, and a percentage reduction desired.

6. The enterprise decarbonization system of claim 1, wherein the plan module shows reductions required each year to achieve the climate goals comprise an effect of previously achieved reductions and potential scenarios.

7. The enterprise decarbonization system of claim 1, wherein the plan module is further configured to enable the user to create reductions specified in a scenario and automatically send the reductions to relevant marketplace as a draft deal.

8. The enterprise decarbonization system of claim 1, wherein the act module is further configured to facilitate a section that shows various major subdivisions created in data warehouse, and the emissions generated by each within specified base year to target year time period.

9. The enterprise decarbonization system of claim 1, wherein the act module is further configured to enable a user to select a portion of emissions from each subdivision and create a potential emissions reduction by purchasing clean power, RECS or carbon credits.

10. The enterprise decarbonization system of claim 1, wherein the report generated by the report module can be in one of various formats necessary to ensure regulatory compliance in applicable jurisdictions.

11. The enterprise decarbonization system of claim 1, further comprises a PPA platform configured to:
allow a seller to create a project description of a project to list the power to be generated thereby for sale, and provide tools for the seller to manage project credit rating during sales process;
allow a buyer to create a power requirement to seek power for sale and provide tools for the buyer to forecast power load and convert to the power requirement; and
identify congruence between projects and power requirements.

12. The enterprise decarbonization system of claim 11, wherein the PPA platform is further configured to:
enable negotiation between the seller and the buyer only after the buyer consents to negotiate; and
when the negotiation is successful, automatically populate the agreed terms into a form contract to create a power purchase agreement between the seller and the buyer, which is then electronically signed on the PPA platform.

13. The enterprise decarbonization system of claim 12, wherein the PPA platform is further configured to: provide a secondary market that enables the resale of portions of PPAs purchased on platform.

14. The enterprise decarbonization system of claim 11, further comprises a carbon platform configured to:
allow a seller to create a listing to list either verified emissions reductions (also known as carbon credits) or RECs and SRECs for sale;
allow a buyer to create a reduction requirement to seek environmental commodities to be purchased; and
identify congruence between listings and reduction requirements to provide one or more offers to the buyer.

15. The enterprise decarbonization system of claim 14, wherein the carbon platform is further configured to:
require the buyer to act to commence negotiations between the seller and the buyer; and
allow the buyer and the seller to negotiate terms of an agreement.

16. The enterprise decarbonization system of claim 15, wherein the carbon platform is further configured to automatically populate a form contract with the agreed terms to create an Environmental Commodities Purchase Agreement (ECPA), which is then electronically signed on the carbon platform.

17. The enterprise decarbonization system of claim 14, wherein the PPA platform comprises a PPA backend; the sustain platform comprises a sustain backend; the carbon platform comprises a carbon backend; and
wherein the PPA backend and the carbon backend are connected to the sustain backend and each configured to share agreements with the sustain backend.

18. The enterprise decarbonization system of claim 17, wherein the carbon backend is configured to share ECPA with the sustain backend; and wherein the PPA backend is configured to share power purchase agreements with the sustain backend.
